(19) United States
(12) Patent Application Publication
(10) Pub. No.: US 2006/0111091 A1
(43) Pub. Date: May 25, 2006

(54) Apparatus and method for forming image by authenticating caller based on caller identification

(75) Inventor: Eun-young Jung, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/281,691

(22) Filed: Nov. 18, 2005

(30) Foreign Application Priority Data
Nov. 19, 2004 (KR) 2004-0095064

(51) Int. Cl. H04M 15/06

(52) U.S. Cl. 455/415; 379/142.01

(57) ABSTRACT

An apparatus and method for forming an image by authenticating a caller based on the caller identification of the caller are provided. The method includes: receiving caller identification and registering the received caller identification; receiving a call from a communication terminal and determining whether the caller identification of the communication terminal matches the registered caller identification; and forming an image when the caller identification and the registered caller identification match. Accordingly, when the caller calls an image forming apparatus using the communication terminal, the requested image is printed after the caller is authenticated.

### CROSS-REFERENCE TO RELATED APPLICATION

This application claims the benefits under 35 U.S.C. §119(a) of Korean Patent Application No. 10-2004-0095064, filed on Nov. 19, 2004, in the Korean Intellectual Property Office, the entire disclosure of which is hereby incorporated by reference.

### BACKGROUND OF THE INVENTION

1. Field of the Invention

The present invention relates to an apparatus and method for forming an image on a print medium. More particularly, the present invention relates to an apparatus and method for forming an image on a print medium by authenticating a caller based on caller identification.

2. Description of the Related Art

A conventional image forming apparatus receives image data transmitted from a caller through a network and forms images on print media based on the received image data without authenticating the caller. Such a conventional image forming apparatus may be a fax or a multifunctional device.

A conventional image forming apparatus forms unnecessary images because the conventional image forming apparatus forms the image without authenticating the caller. Accordingly, paper and toner in the image forming apparatus are wasted by forming unnecessary unrequested images.

When a ticket for a movie theater or a music concert hall is issued after the ticket is purchased in advance through the Internet or by telephone, authentication of a purchaser based on the purchaser's identification such as a social security number or a driver's license number is typically required.

If the purchaser does not have the purchaser's required identification, the ticket is not issued to the purchaser.

When using an automatic ticketing device for issuing a ticket purchased in advance through the Internet or by telephone, the automatic ticketing device requires the purchaser to enter the purchaser's identification number, such as their social security number or the driver's license number. Therefore, the purchaser must input the identification number using an input panel of the automatic ticketing device or other image forming device. This can be very annoying and inconvenient to the purchaser.

### SUMMARY OF THE INVENTION

The present invention provides a method for forming an image by authenticating a caller based on caller identification.

Also, the present invention provides an apparatus for forming an image by authenticating a caller based on caller identification.

According to an aspect of the present invention, there is provided a method of forming an image by authenticating a caller based on caller identification of the caller, the method comprising the steps of receiving caller identification and registering the received caller identification; receiving a call from a communication terminal and determining whether the caller identification of the communication terminal matches the registered caller identification; and forming an image when the caller identification and the registered caller identification match.

According to another aspect of the present invention, there is provided an apparatus for forming an image by authenticating a caller based on caller identification of the caller, the apparatus comprising a caller identification registering unit for receiving the caller identification and registering the received caller identification; a caller identification comparing unit for determining whether a caller identification of a communication terminal matches the registered caller identification when a call is received from the communication terminal of the caller; and an image forming unit for forming the image requested by the caller based on a comparison result of the caller identification comparing unit.

### BRIEF DESCRIPTION OF THE DRAWINGS

The above and other features and advantages of the present invention will become more apparent by describing in detail exemplary embodiments thereof with reference to the attached drawings in which:

FIG. 1 is a flowchart illustrating a method for forming an image by authenticating a caller based on caller identification according to an embodiment of the present invention; and

FIG. 2 is a block diagram of an apparatus for forming an image by authenticating a caller based on caller identification according to an embodiment of the present invention.

It should be understood that throughout the drawings like reference numbers refer to like features, structures and elements.

### DETAILED DESCRIPTION OF EXEMPLARY EMBODIMENTS

Exemplary embodiments of the present invention will now be described more fully with reference to the accompanying drawings. The invention may, however, be embodied in many different forms and should not be construed as being limited to the embodiments set forth herein; rather, these embodiments are provided so that this disclosure will be thorough and complete, and will fully convey the concept of the invention to those skilled in the art.

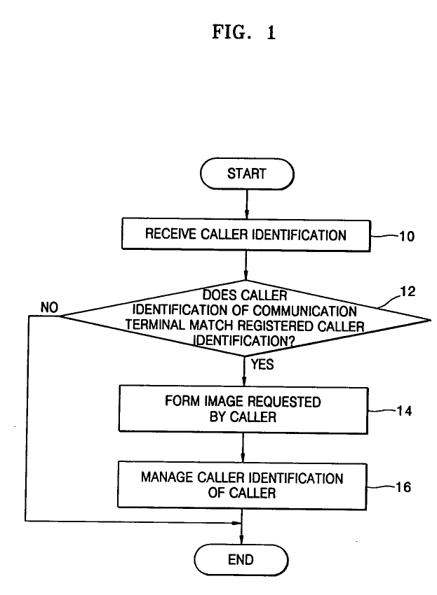

FIG. 1 is a flowchart illustrating a method for forming an image by authenticating a caller based on caller identification according to an embodiment of the present invention.

Referring to FIG. 1, the caller identification of a caller is input to an image forming apparatus and the input caller identification is registered in operation 10. The caller identification of the caller is a telephone number of a communication terminal of the caller or the name of the caller. In the present embodiment, the telephone number of the communication terminal is input to the image forming apparatus and registered as the caller identification.

The caller identification may be input to the image forming apparatus through a network, by using a portable memory, or by using an input panel of the image forming apparatus. That is, the caller inputs the caller identification of the communication terminal into a host connected to the network such as the Internet and the input caller identification is transmitted to the image forming apparatus through the network to register the caller identification. Also, the caller identification may be input to the image forming apparatus using a portable memory such as a universal serial bus (USB) memory device. That is, the caller stores the caller identification in the portable memory device and directly connects the portable memory to the image forming apparatus to input and register the caller identification. Furthermore, the caller identification may be input to the image forming apparatus by activating corresponding key buttons of the input panel of the image forming apparatus.

After inputting the caller identification through the network or by using the portable memory or the input panel, the input caller identification is registered as the caller identification of the communication terminal.

The method of the present embodiment may further comprise the steps of receiving a reservation for forming images from the caller. The operation of receiving the reservation may be performed before, after, or simultaneously with operation 10. The caller identification of the caller may be input to the image forming apparatus and registered when the caller makes a reservation to form an image. For example, the caller may input the caller identification when the caller reserves tickets for a movie theatre or a music concert. The input caller identification is registered as the caller identification of the caller at the time when the caller reserves the tickets.

The image forming apparatus determines whether the caller identification of the communication terminal matches the registered caller identification in operation 12 when the image forming apparatus receives a call from the communication terminal of the caller.

When the image forming apparatus receives a call from the communication terminal, the image forming apparatus enters a communication mode and charges the cost of the data communication to the caller in the communication mode. The image forming apparatus of the present embodiment may determine whether the caller identification of the communication terminal matches the registered caller information before the image forming apparatus enters the communication mode. That is, the image forming apparatus may determine the caller identification of the communication terminal before charging the cost of communicating to the caller. Therefore, the caller is not charged for authenticating the caller identification.

The communication terminal of the caller may be a wireless communication terminal, a wired communication terminal or a personal digital assistant (PDA). The wired communication terminal is a telephone commonly used in a home or office. The wireless communication terminal is preferably a portable phone capable of wireless communication. The PDA is a portable device having functions such as wireless communication, input of data by handwriting, managing and scheduling personal data and transferring data to a computer.

If the caller identification of the communication terminal matches a registered caller identification, the image forming apparatus forms images requested by the caller in operation 14. That is, the image forming apparatus authenticates the caller of the communication terminal by comparing the caller identification of the communication terminal with the registered caller identification. After authenticating, the image forming apparatus forms images previously reserved or currently requested.

Particularly, the image forming apparatus prints the image requested by the caller on printing paper. For example, if the caller purchases a ticket in advance through the Internet or by using a telephone, a ticket issuing apparatus may print the ticket after the ticket issuing apparatus authenticates the caller.

After forming the image, the image forming apparatus manages the caller identification of the caller in operation 16. That is, the caller identification is stored or updated to indicate that the requested image has already been printed. Particularly, the image forming apparatus deletes the caller identification of the caller requesting to form images. The caller identification is deleted to prevent repeated forming of the previously formed image. For example, if the ticket is issued to the caller after authenticating the caller, the caller identification of the caller is deleted to prevent repeated issuing of the same ticket to the caller.

An image forming method according to an embodiment of the present invention may include paying the cost of using the image forming apparatus. The operation of paying the cost may be performing simultaneously with any other operations of the image forming method. Particularly, in an exemplary embodiment of the present invention, the operation of paying the cost is performed after the operation of receiving the reservation or the operation of forming image.

The cost of using the image forming apparatus may be paid by billing the cost of forming the image with a communication service charge of the communication terminal, by using an HTML based web-page through the Internet, or by using an automatic banking system.

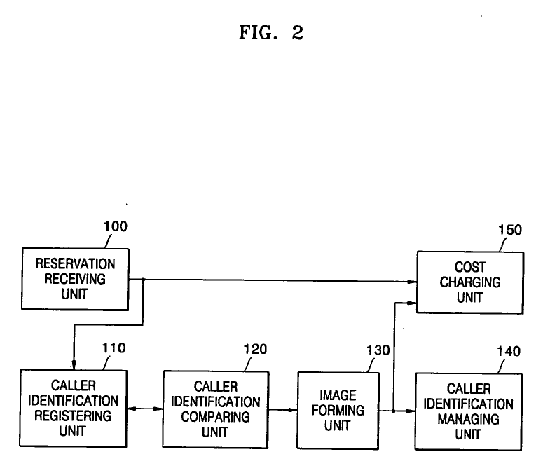

Hereinafter, an apparatus for forming an image by authenticating a caller based on caller identification will be explained in more detail with reference to FIG. 2.

FIG. 2 is a block diagram of an apparatus for forming an image by authenticating a caller based on caller identification according to an embodiment of the present invention.

Referring to FIG. 2, the image forming apparatus comprises a reservation receiving unit 100, a caller identification registering unit 110, a caller identification comparing unit 120, an image forming unit 130, a caller identification manager 140 and a cost charging unit 150.

The reservation receiving unit 100 receives a reservation for forming an image from a caller. For example, the reservation receiving unit 100 receives and stores information related to a reservation of a ticket for a movie theater or a music concert hall when the caller reserves the ticket in advance through the Internet or by telephone. In the present embodiment, the reservation receiving unit 100 receives the reservation information through a network such as the Internet. The reservation information may preferably comprise caller identification. The reservation information is outputted to the caller identification registering unit 110 and the cost charging unit 150.

The caller identification registering unit 110 receives the caller identification and registers the received caller identification. In the present embodiment, the caller identification of the caller is received and registered when the caller makes a reservation to form an image. That is, the caller identification registering unit 110 receives the caller identification included in the reservation information from the reservation receiving unit 100 and registers the received caller identification as information for authenticating the caller.

In the present embodiment, the caller identification registering unit 110 receives a telephone number of a communication terminal and registers the telephone number as the caller identification.

The caller identification registering unit 110 receives the caller identification through the network, from a portable memory or through an input panel of the image forming apparatus. In other words, the caller inputs the caller identification of the communication terminal into a host connected to the network such as the Internet and the input caller identification is transmitted to the caller identification registering unit 110 of the image forming apparatus through the network to input and register the caller identification. Alternatively, the caller identification may be input to the caller identification registering unit 110 of the image forming apparatus by using the portable memory such as a universal serial bus (USB) memory. That is, the caller stores the caller identification in the portable memory and directly connects the portable memory to the image forming apparatus to input the caller identification. Furthermore, the caller identification may be input to the caller identification registering unit 110 of the image forming apparatus by activating corresponding key buttons of the input panel of the image forming apparatus.

The caller information comparing unit 120 determines whether caller identification of a communication terminal matches the registered caller identification when the image forming apparatus receives a call from the communication terminal (not shown). When the image forming apparatus receives a call from the communication terminal (not shown), the caller identification comparing unit 120 reads the caller identification registered in the caller identification registering unit 110. The caller identification comparing unit 120 than compares the registered caller identification and the caller identification of the communication terminal to determine whether the caller identification of the communication terminal matches the registered caller identification. The result of the comparison is transmitted to the image forming unit 130.

In the present embodiment, the caller identification comparing unit 120 determines whether the caller identification of the communication terminal matches the registered caller identification before the image forming apparatus enters into a communication mode. Accordingly, the caller is not charged the cost of using a communication service for connecting to the image forming apparatus when authenticating the caller when the communication terminal calls the image forming apparatus.

The communication terminal is preferably a wired communication terminal, a wireless communication terminal or a personal digital assistant (PDA).

The image forming unit 130 forms the image requested by the caller based on the result of the comparison output from the caller identification comparing unit 120 and outputs the result of forming the image to the caller identification manager 140 and the cost charging unit 150. In the present embodiment, the image forming unit 130 forms the image on printing paper. Thus, if, for example, the caller reserves a ticket through the network or by telephone and the caller is authenticated, the image forming unit 130 prints the ticket and outputs the printed ticket.

The caller identification manager 140 manages the caller identification of the caller requesting to form the image. The caller identification manager 140 stores and updates the information indicating that the image forming unit 130 forms the image requested by the caller.

In the present embodiment, the caller identification manager 140 deletes the caller identification of the communication terminal after forming the image. The caller identification is deleted to prevent repeatedly printing the previously printed ticket.

The cost charging unit 150 charges the cost of using the image forming apparatus when the cost charging unit 150 receives the result of forming the image or receives the reservation from the caller.

The cost charging unit 150 may charge the cost by billing the cost with a communication service charge of the communication terminal, by using an HTML based web-page through the Internet, or by using an automatic banking system.

The above mentioned image forming apparatus may preferably be a fax, a multifunctional device having a function for receiving caller identification, a ticket issuing apparatus having a function for receiving the caller identification or the like. In particular, the ticket issuing apparatus is preferably an apparatus for issuing tickets for a movie theater, a music concert hall, an amusement park, transportation, automobile parking or the like.

As mentioned above, embodiments of the present invention form an image requested from a caller by authenticating the caller based on the caller identification of the caller.

Also, embodiments of the present invention simply authenticate the caller by receiving a call from the communication terminal of the caller.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method for an image forming to form an image by authenticating a caller based on a caller identification of the caller, the method comprising the steps of:
receiving a caller identification and registering the received caller identification;
receiving a call from a communication terminal and determining whether the caller identification of the communication terminal matches the registered caller identification; and
forming an image when the caller identification and the registered caller identification match.

2. The method of claim 1, wherein the telephone number of the communication terminal is the caller identification.

3. The method of claim 1, wherein the caller identification is received through a network, or by using a portable memory or an input panel on the image forming device.

4. The method of claim 1, wherein the caller identification of the communication terminal is determined to match the registered caller identification before a communication mode is entered when a call is received from the communication terminal.

5. The method of claim 1, wherein the communication terminal is a wired communication terminal, a wireless communication terminal or a personal digital assistant.

6. The method of claim 1, wherein the image is printed on printing paper.

7. The method of claim 1, further comprising the steps of receiving a reservation to form the image from the registered caller.

8. The method of claim 7, wherein the receiving and registering the caller identification and the receiving the reservation steps are performed simultaneously.

9. The method of claim 1, further comprising the steps of managing the caller identification of the caller requesting to form the image after the forming of the image.

10. The method of claim 9, wherein the step of managing the caller identification of the caller comprises the step of deleting the caller identification of the caller.

11. The method of claim 1, further comprising the step of charging the cost of forming the image by billing the cost with a communication service charge of the communication terminal, using an HTML based web-page through the Internet, or using an automatic banking system.

12. An apparatus for forming an image by authenticating a caller based on caller identification of the caller, the apparatus comprising:
a caller identification registering unit for receiving the caller identification and registering the received caller identification;
a caller identification comparing unit for determining whether a caller identification of a communication terminal matches the registered caller identification when a call is received from the communication terminal of the caller; and
an image forming unit for forming the image requested by the caller based on a comparison result of the caller identification comparing unit.

13. The apparatus of claim 12, wherein a telephone number of the communication terminal is the caller identification.

14. The apparatus of claim 12, wherein the caller identification registering unit receives the caller identification through a network, from a portable memory, or through an input panel.

15. The apparatus of claim 12, wherein the caller identification comparing unit determines whether the caller identification of the communication terminal matches the registered caller identification before the apparatus enters into a communication mode when the apparatus receives a call from the communication terminal.

16. The apparatus of claim 12, wherein the communication terminal is a wired communication terminal, a wireless communication terminal or a personal digital assistant.

17. The apparatus of claim 12, wherein the image forming unit prints the image on printing paper.

18. The apparatus of claim 12, further comprising a reservation receiving unit for receiving a reservation to form the image from the caller.

19. The apparatus of claim 18, wherein the caller identification registering unit receives the caller identification of the communication terminal when the reservation is received from the communication terminal.

20. The apparatus of claim 12, further comprising a caller identification managing unit for managing the caller identification of the caller requesting to form the image.

21. The apparatus of claim 20, wherein the caller identification managing unit deletes the caller identification of the caller.

22. The apparatus of claim 12, further comprising a cost charging unit for charging a cost of forming the image by billing the cost with a communication service charge of the communication terminal, using an HTML based web-page through an Internet, or using an automatic banking system.

23. The apparatus of claim 12, wherein the apparatus is a fax, a multifunctional device having a function for receiving the caller identification, or a ticket issuing device having a function for receiving the caller identification.
